(19) United States
(12) Patent Application Publication
(10) Pub. No.: US 2024/0294086 A1
(43) Pub. Date: Sep. 5, 2024

(54) CHARGING AND POWER SUPPLY OPTIMIZATION METHOD AND APPARATUS FOR CHARGING MANAGEMENT SYSTEM

(71) Applicant: BORG WARNER NEW ENERGY (XIANGYANG) CO., LTD

(72) Inventors: Yuhong Sun, Shanghai (CN); Fei Pan, Shanghai (CN); Ke Dai, Shanghai (CN); Yong Kang, Shanghai (CN)

(21) Appl. No.: 18/272,013

(22) PCT Filed: Jan. 10, 2022
(86) PCT No.: PCT/CN2022/070920

§ 371 Date: Jul. 12, 2023

(30) Foreign Application Priority Data
Jan. 12, 2021 (CN) 2021100331911

(51) Int. Cl. B60L 53/62; B60L 53/66; B60L 53/67

(52) U.S. Cl. CPC B60L 53/62; B60L 53/66; B60L 53/67

(57) ABSTRACT

Charging and power supply optimization method and apparatus for a charging management system are provided. The method includes: obtaining information about power supply, transformation and distribution of a charging station, capability information of a charging facility, output information of a charging terminal, and charging demand information of an electric vehicle, determining a charging capability, power supply capability and an actual charging capacity of a charging facility system at the charging station, obtaining a model output result based on a pre-trained deep learning time series prediction algorithm model, generating a charging power allocation instruction in combination with an actual charging capacity of a charging facility system at the charging station, and a charging demand of a to-be-charged electric vehicle, and distributing electric energy to each charging facility. Due to use of deep learning to establish a continuously optimized management control model, energy supply and a charging capability resource of a charging facility is optimized and utilization efficiency is improved.

### CROSS REFERENCE TO RELATED APPLICATION

This application is a national stage application of International Patent Application No. PCT/CN2022/070920, filed on Jan. 10, 2022, which claims priority to Chinese Patent Application No. 202110033191.1, filed with the China National Intellectual Property Administration on Jan. 12, 2021 and entitled “CHARGING AND POWER SUPPLY OPTIMIZATION METHOD AND APPARATUS FOR CHARGING MANAGEMENT SYSTEM”, which is incorporated herein by reference in its entirety.

### TECHNICAL FIELD

The present disclosure relates to the technical field of charging management, and in particular, to charging and power supply optimization method and apparatus for a charging management system.

### BACKGROUND

As an important infrastructure, electric vehicle charging piles are related to car experience of vehicles. With the increase in a quantity of new energy vehicles and the improvement of cruising ranges, a demand for charging piles is gradually increasing, and people increasingly value construction and development of charging infrastructure. There are a large quantity of existing charging facilities and a large charging capacity, but once the charging facilities are built, charging output interfaces and parking space are fixed, and are also affected by a connected power supply capability. Due to mobility of charged electric vehicles, a quantity of charged electric vehicles connected to the charging facilities, a time required for charging and a required charging capacity are all uncertain, there is usually a phenomenon in which, during peak hours, it is often difficult to find a charging pile, and vehicles need to line up for charging and wait for a long time, and during low peak hours, the charging facilities are idle and a utilization rate is not high. Sometimes, even if the charging facilities are working at maximum charging output, due to existence of a factor of a power demand curve in a charging process, and limitation of charging guns and parking space, during peak hours, there is also a phenomenon that a charging facility is rich in capability but a car is forced to wait for a seat.

The conventional charging facility management system does not have a capability to predict charging supply and demand, and relies only on manual adjustments in combination with actual charging usage. Efficiency is low and contradictions in a vehicle charging process are prominent, and it is impossible to maximize efficiency of charging output and power supply of charging facilities.

### SUMMARY

A purpose of the present disclosure is to resolve defects of the conventional technology and provide charging and power supply optimization method and apparatus for a charging management system. Due to use of deep learning to establish a continuously optimized management control model, energy supply and a charging capability resource of a charging facility is optimized and utilization efficiency is improved.

The technical purpose of the present disclosure is implemented by using the following technical solution, a charging and power supply optimization method for a charging management system, where the method includes.

S1: obtaining information about power supply, transformation and distribution of a charging station, capability information of a charging facility, output information of a charging terminal, and charging demand information of an electric vehicle;

S2: determining a charging capability, a power supply capability, and an actual charging capacity of a charging facility system at the charging station based on the information about power supply, transformation and distribution of the charging station, the capability information of the charging facility, the output information of the charging terminal, and the charging demand information of the electric vehicle;

S3: inputting the charging capability, the power supply capability, and the actual charging capacity into a pre-trained deep learning time series prediction algorithm model, and obtaining a model output result;

S4: generating a charging power allocation instruction based on the model output result, an actual charging capacity of a charging facility at the charging station, and a charging demand of a to-be-charged electric vehicle; and

S5: distributing electric energy to each charging facility based on the charging power allocation instruction, and charging the electric vehicle by using a charging terminal installed on the charging facility.

By adopting the above technical solution, the charging management system provided by the present disclosure includes a charging capability execution management unit and a charging capability training optimization unit. The charging capability training optimization unit forms a pre-trained deep learning time series prediction algorithm model by training, testing and verifying an initial machine learning model. In a specific electric vehicle charging application scenario, real-time collected data is input into the deep learning time series prediction algorithm model. A charging power allocation instruction is generated based on the model output result, and in combination with an actual charging capacity of a charging facility, and a charging demand of a to-be-charged electric vehicle, and is sent to the charging capability execution management unit. The charging capability execution management unit adjusts an energy supply and charging ratio of the charging facility system in real time based on an actual demand, so that output of the charging terminal can best meet a charging demand of electric vehicles, and implement maximization of charging output and power supply efficiency. At the same time, in a process of using the deep learning time series prediction algorithm model, in combination with an actual charging application scenario, the model is continuously trained, tested, verified and optimized, so that the charging facilities and corresponding power supply efficiency can be continuously optimized. The charging and power supply optimization method for a charging management system provided by the present disclosure is to use AI deep learning to establish a continuously optimized management control model, output an optimized control model that is of energy control supply-demand balance of a charging system and that is optimal for a charging terminal to use, thereby maximizing charging and power consumption efficiency of the charging facility system.

The present disclosure has the following beneficial effects:

1. The charging and power supply optimization method provided by the present disclosure implements maximization of charging output and power supply efficiency when the charging station can best meet the charging demand of electric vehicles, continuously optimizes the charging facilities and corresponding power supply efficiency, and uses Al deep learning to establish a continuously optimized management control model to maximize the charging and power consumption efficiency of the charging facility system.

2. In a specific electric vehicle charging application scenario, real-time collected data is input into the deep learning time series prediction algorithm model. A charging power allocation instruction is generated based on the model output result, and in combination with an actual charging capacity of a and a charging demand of a to-be-charged electric vehicle An energy supply and charging ratio of the charging facility system is adjusted in real time based on an actual demand, so that output of the charging terminal can best meet a charging demand of electric vehicles, and implement maximization of charging output and power supply efficiency. At the same time, in a process of using the deep learning time series prediction algorithm model, in combination with an actual charging application scenario, the model is continuously trained, tested, verified and optimized, so that the charging facilities and corresponding power supply efficiency can be continuously optimized.

3. Before training the model, it is necessary to collect a large amount of historical data and real-time data, create a feature database, and repeatedly train, verify and optimize the model through the data in the feature database, and associated data is used to calculate the charging demand of electric vehicles, a real-time charging capacity of a charging device and power supply of the charging station, participate in learning and training to continuously optimize the charging power management module of the system, predict a charging demand and response capability of each charging terminal, and compare the charging capacity of each charging terminal with a power demand curve of an electric vehicle power battery charging process in real time, to optimally respond to a charging demand in real time and control a charging capability.

4. After the deep learning time series prediction algorithm model is formed, the model can be continuously trained, verified and optimized by inputting real-time values in combination with an actual charging application scenario, to output an optimized control model of energy control supply-demand balance of the charging system. The charging and energy supply optimization method is continuously optimized, and flexibly adjusted and changed based on an actual situation, to maximize charging and power consumption efficiency of the charging facility system.

5. Under resource contradiction of a high charging demand and insufficient charging terminals, this system can be used to optimize scheduling, thereby improving supply and demand adaptability between charging facilities, power supply and distribution, charging terminals, and to-be-charged electric vehicles, thus providing room for dynamic resource optimization implementation of this system.

### BRIEF DESCRIPTION OF THE DRAWINGS

In order to describe the technical solutions in the examples of the present disclosure more clearly, the accompanying drawings required to describe the examples are briefly described below. Apparently, the accompanying drawings described below are only some examples of the present disclosure. Those of ordinary skill in the art may further obtain other accompanying drawings based on these accompanying drawings without inventive effort.

FIG. 1 is a schematic diagram of a charging and power supply optimization method for a charging management system according to the present disclosure;

FIG. 2 is a schematic diagram of implementation steps of a deep learning model of a charging and energy supply optimization method for a charging management system according to the present disclosure;

FIG. 3 is a schematic diagram of an energy control output sub-process of a charging management system according to the present disclosure;

FIG. 4 is a schematic diagram of a charging and power supply optimization apparatus for a charging management system according to the present disclosure; and

FIG. 5A and FIG. 5B are power demand change curves diagram of a charging process of a power battery of a charged electric vehicle and a charging terminal according to the present disclosure.

### REFERENCE NUMERALS

1. data management module; 2 data collection module; 3. data storage module; 4. data training and output module: 5. man-machine interaction scheduling module; 6. communication module; 7 cloud server; 8. charging capability execution management unit; and 9. charging capability training optimization unit.

### DETAILED DESCRIPTION OF THE EMBODIMENTS

The technical solution in the present disclosure will be clearly and completely described below in conjunction with the examples of the present disclosure. Apparently, the described embodiments are only some but not all embodiments of the present disclosure. All other examples obtained by a person of ordinary skill in the art based on the examples of the present disclosure without creative efforts shall fall within the protection scope of the present disclosure.

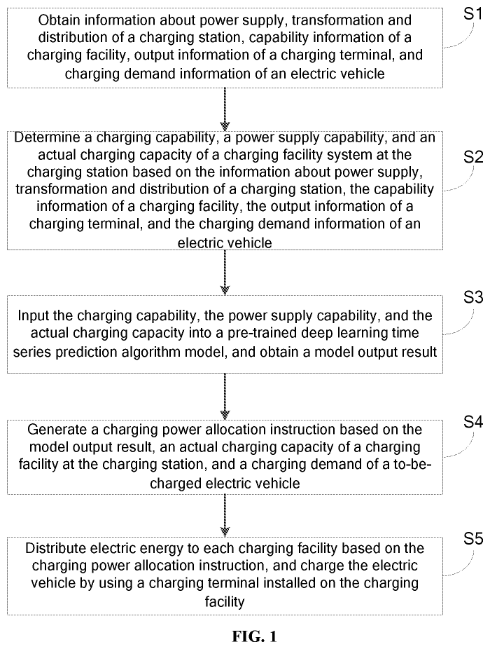

FIG. 1 is a schematic diagram of a charging and power supply optimization method for a charging management system according to the present disclosure, including the following steps.

Step S1: Obtain information about power supply, transformation and distribution of a charging station, capability information of a charging facility, output information of a charging terminal, and charging demand information of an electric vehicle.

Step S2: Determine a charging capability, a power supply capability, and an actual charging capacity of a charging facility system at the charging station based on the information about power supply, transformation and distribution of the charging station, the capability information of the charging facility, the output information of the charging terminal, and the charging demand information of the electric vehicle.

Step S3: Input the charging capability, the power supply capability, and the actual charging capacity into a pre-trained deep learning time series prediction algorithm model, and obtain a model output result.

Step S4: Generate a charging power allocation instruction based on the model output result, an actual charging capacity of a charging facility at the charging station, and a charging demand of a to-be-charged electric vehicle.

Step S5: Distribute electric energy to each charging facility based on the charging power allocation instruction, and charge the electric vehicle by using a charging terminal installed on the charging facility.

It should be noted that, the charging management system provided by the present disclosure includes a charging capability execution management unit 8 and a charging capability training optimization unit 9. The charging capability training optimization unit 9 forms a pre-trained deep learning time series prediction algorithm model by training, testing and verifying an initial machine learning model. In a specific electric vehicle charging application scenario, real-time collected data is input into the deep learning time series prediction algorithm model. A charging power allocation instruction is generated based on the model output result, and in combination with an actual charging capacity of a charging facility, and a charging demand of a to-be-charged electric vehicle, and is sent to the charging capability execution management unit 8. The charging capability execution management unit 8 adjusts an energy supply and charging ratio of the charging facility system in real time based on an actual demand, so that output of the charging terminal can best meet a charging demand of electric vehicles, and implement maximization of charging output and power supply efficiency. At the same time, in a process of using the deep learning time series prediction algorithm model, in combination with an actual charging application scenario, the model is continuously trained, tested, verified and optimized, so that the charging facilities and corresponding power supply efficiency can be continuously optimized.

It should be noted that the charging capability of the charging facility system is a sum of a rated power of all charging facilities, and a power supply capability of the charging facility system is a maximum output capacity that can be provided after a rated capacity of a charging station energy supply transformer minus power used by another device in a grid. A charging capability is set as ΣP, the power supply capacity is set as ΣQ, the actual charging capacity is set as ΣS, a rated power of a single charging facility is P, a quantity of charging facilities is m, and a quantity of charging terminals installed on each charging facility is n, the following can be obtained.

$$\sum P = P 1 + P 2 + … + Pm$$

$$\sum Q \geq \sum S$$

The output power of the charging facility Pm≥Sₘ₁+Sₘ₂+ . . . +Sₘₙ, Sₘ is an actual charging power of a charging terminal, which is directly related to a charged electric vehicle, and a value thereof is 0 when no electric vehicle is connected. The maximum output power of the charging terminal is less than or equal to a maximum receiving capacity of the electric vehicle, which is controlled by a battery charging management system in the electric vehicle and also controlled by the power supply capability of the system.

An actual output power of a charger is Pn=Sn. An actual power required for charging is not only greatly affected by a power capacity of the charged electric vehicle and an ambient temperature, but also by the dynamic SOC of a power battery of a charged electric vehicle. According to a power demand curve generated by change of a charging process of the power battery of a charged electric vehicle, it can be learned that when the power battery of a charged electric vehicle reaches a certain capacity, the power battery of a charged electric vehicle enters a low-current uniform charging stage that takes a long time. In this case, if ΣQ is surplus, even if the charging facilities are insufficient, once a charging demand of a new electric vehicle is received, a charging terminal should be selectively controlled, and a charging completion command should be issued to access the new charging demand, to charge the new electric vehicle and monitor a charging status in real time.

The charging and power supply optimization method for a charging management system provided by the present disclosure is to use AI deep learning to establish a continuously optimized management control model, and output an optimized control model that is of energy control supply-demand balance of a charging system and that is optimal for a charging terminal to use, thereby maximizing charging and power consumption efficiency of the charging facility system.

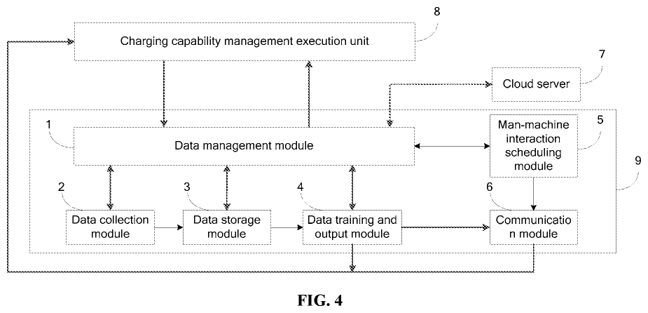

Specifically, with reference to FIG. 4, the charging management system of the present disclosure includes a charging capability execution management unit 8, a charging capability training optimization unit 9 and a cloud server 7. The charging capability execution management unit 8 includes a power supply, transformation and distribution station, a charging facility distribution control module and several charging facilities. The charging facility is equipped with several charging terminals, and the charging facilities are connected to the charging facility distribution control module The charging facility distribution control module is connected to the power supply, transformation and distribution station, and the charging facility distribution control module is configured to: receive the charging power allocation instruction sent by the charging capability training optimization unit, and control the distribution of electric energy to charging facilities according to the charging power allocation instruction, and control distribution of electric energy to the charging facilities based on the charging power allocation instruction. The charging facility is configured to: convert electric energy into working power required by a to-be-charged electric vehicle, and perform DC fast charging or AC slow charging for the to-be-charged electric vehicle through the charging terminal.

The charging capability training optimization unit 9 includes a data management module 1, a data collection module 2, a data storage module 3, and a data training and output module 4. The data collection module 2, the data storage module 3, and the data training and output module 4 are connected to the charging facility distribution control module through the data management module 1. The charging facility distribution control module 9 further includes a man-machine interaction scheduling module 5 and a communication module 6. The man-machine interaction scheduling module 5 is separately connected to the data management module 1 and the communication module 6. The communication module 6 is connected to the data training and output module 4.

The cloud server 7 supports comprehensive management at a system level, supports remote sharing, collection and processing, interoperability and scheduling of data information through a common protocol of a communication interface, and serves as extension of a data management center of the charging capability training optimization unit 8 and jointly manages and shares expansion with a local area network, accepts migration and embedding of an AI training environment and model, and better utilizes advantages of artificial intelligence technology under big data to train and verify an output control model, thereby optimizing data sharing and machine deep learning under a local multi-station charging management system, realizing complementarity and optimization of a charging capability resource of each system, and maximizing charging and power efficiency of a local charging facility system.

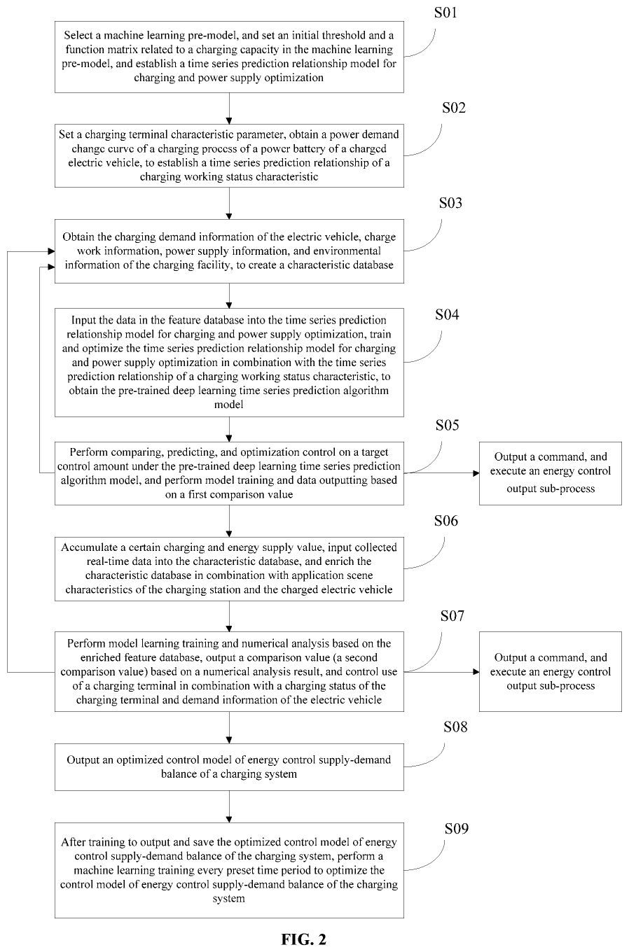

Refer to FIG. 2. Before Step S1 of obtaining information about power supply, transformation and distribution of a charging station, capability information of a charging facility, output information of a charging terminal, and charging demand information of an electric vehicle, the method further includes:

Step S01: Select a machine learning pre-trained model, and set an initial threshold and a function matrix related to a charging capacity in the machine learning pre-trained model, and establish a time series prediction relationship model for charging and power supply optimization.

Step S02: Sett a charging terminal characteristic parameter, obtain a power demand change curve of a charging process of a power battery of a charged electric vehicle, to establish a time series prediction relationship of a charging working status characteristic.

Step S03: Obtain the charging demand information of the electric vehicle, charge work information, power supply information, and environmental information of the charging facility, to create a characteristic database.

Step S04: Input the data in the feature database into the time series prediction relationship model for charging and power supply optimization, train and optimize the time series prediction relationship model for charging and power supply optimization in combination with the time series prediction relationship of a charging working status characteristic, to obtain the pre-trained deep learning time series prediction algorithm model.

It should be understood that before using the pre-trained deep learning time series prediction algorithm model, it is necessary to establish a model and perform training and verification on the model First, a machine learning pre-trained model is selected, and an initial threshold and a function matrix related to a charging capacity in the model is set, and a time series prediction relationship model for charging and power supply optimization is established. When the machine learning pre-trained model is selected, selection needs to be performed in combination with an application scenario. After an initial model is selected, an initial threshold related to the charging capacity in the specific charging system is input, including a maximum power supply capability of an electrical power supply, transformation and distribution station of the charging system, a total rated charging capability of a charging facility system, a rated charging capacity of each charging facility and quantity and location information of charging terminals thereof, used to dynamically analyze and process charging and power supply capabilities of the charging system, and clarify a status characteristic of the application scenario.

After a time series prediction relationship for charging and power supply optimization is established, it is also necessary to establish a time series prediction relationship of a charging working status characteristic, specifically including: setting a corresponding relationship between a charging capacity and time of each charging terminal as a main variable, which is used to correspond to and respond to a charging demand of the electric vehicle, and establish a one-to-one corresponding time series prediction relationship trend between the electric vehicle entering a charging status and the charging terminal. It should be noted that a power demand change curve during a charging process of a power battery of a charged electric vehicle can be derived from a historical database, or from a battery management system BMS of the to-be-charged electric vehicle. The power demand change curve during a charging process of a power battery of a charged electric vehicle can be obtained by reading the battery management system BMS of the electric vehicle through a mobile APP or an internet server or charging terminal, used for supervised learning of a real-time charging energy status of the charging terminal and the charged electric vehicle, and improving accuracy of energy adaptation control.

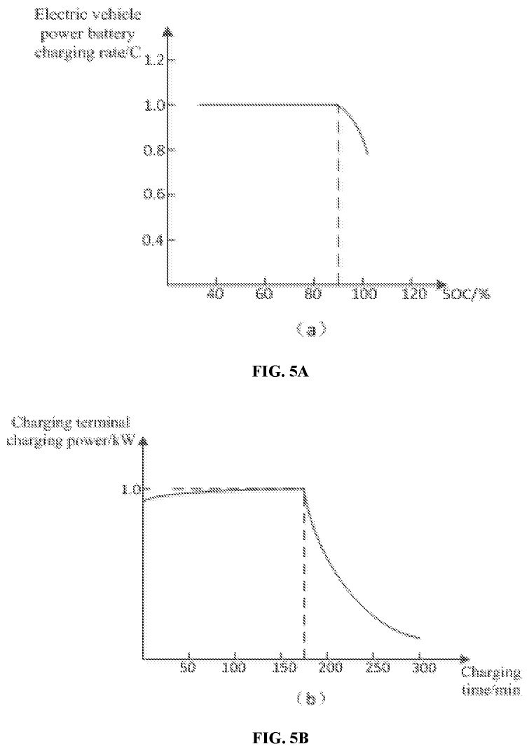

As shown in FIG. 5A, most of the conventional electric vehicle power batteries use lithium-ion batteries, and A charging process takes a long time. A power of a charging terminal is generally selected to meet a maximum rated power required for electric vehicle charging, to ensure that when a charged electric vehicle requires maximum capacity charging, the charging terminal can provide corresponding electric energy. A charging capacity required by the power battery is also affected by a remaining capacity of the battery, that is, a dynamic state of charge SOC of the power battery (a percentage of remaining power of the power battery), and a ratio of the remaining capacity to a battery capacity. When SOC=1, the battery is fully charged. When SOC=0, it means that the battery is fully discharged, which cause great damage to the power battery. During actual application, when the SOC is less than 50%, charging and battery correction should be performed. FIG. 5A is a typical charge current curve of a power battery under different SOCs at room temperature. As a charging process of the power battery changes, the output power of the charger also changes accordingly. FIG. 5B reflects a curve of an actual output power of a charging terminal changing with the power charging process.

It can be seen from the relationship curve between the charging capacity and the SOC of the power battery of the electric vehicle in this embodiment shown in FIG. 5A that when the power battery capacity of the electric vehicle reaches 90% of the rated capacity, a required charging power decreases rapidly, and correspondingly is characterized by a charging time: it takes 250 minutes to 300 minutes for the power battery capacity of the electric vehicle in this embodiment to be fully charged, but in fact only about 150 minutes after a start of charging requires fast charging at full power, which reaches 90% of the rated capacity of the electric vehicle. An actual output capacity of the charging terminal gradually decreases over time. That is to say, if the electric vehicle needs to be fully charged to the rated capacity, a system can provide support in a case of a surplus of charging terminals. In a case of resource conflicts where a charging demand is high but charging terminals are insufficient, the system can be used for optimal scheduling, to improve supply and demand adaptability between charging facilities, power supply and distribution, charging terminals, and to-be-charged electric vehicles, thus providing space for dynamic optimization of resources in this system.

Before training the model, it is necessary to collect a large amount of historical data and real-time data, create a feature database, that is, a data set for model training, and repeatedly train, verify and optimize the model by using the data in the feature database. The data is collected by the data collection module 2, and after being processed by the data management module 1, the data enters the data storage module 3 for storage, which provides the historical data and the real-time data for the data training and output module 4, and trains and optimize the initially established time series prediction relationship model for charging and power supply optimization. Relevant collected parameters include a working information status parameter of the charging facility, vehicle quantity and model parameters of charged electric vehicles, a charging demand parameter of the charged electric vehicle, a power supply capability parameter, an environmental status parameter, working status scene data, and a man-machine interaction control parameter. Associated data is used to calculate the charging demand of electric vehicles, a real-time charging capacity of a charging device and power supply of the charging station, participate in learning and training to continuously optimize the charging power management module of the system, predict a charging demand and response capability of each charging terminal, and compare the charging capacity of each charging terminal with a power demand curve of an electric vehicle power battery charging process in real time, to optimally respond to a charging demand in real time and control a charging capability.

It should be noted that when creating the characteristic database, a training set and a test set are included. Initially, 90% is set as training data and 10% is set as test data, as the data continues to increase, 95% is adjusted as training data and 5% is adjusted as test data, to prepare for machine learning to optimize the output model. Specifically, based on charging data collected in the past two years, hourly charging data is used as a basic time series unit, and the data is divided into two groups: 90% is the training data set and 10% is the test data set. After historical analysis of the past data, time series predictions and modeling are performed, and then the test data is used to test and adjust control errors, which can well manage impact of fluctuations in electric vehicle charging loads caused by seasonal environmental changes.

Refer to FIG. 2. After step S04 of inputting the data in the feature database into the time series prediction relationship model for charging and power supply optimization, training and optimizing the time series prediction relationship model for charging and power supply optimization in combination with the time series prediction relationship of a charging working status characteristic, to obtain the pre-trained deep learning time series prediction algorithm model, the method further includes:

Step S05: Perform comparing, predicting, and optimization control on a target control amount under the pre-trained deep learning time series prediction algorithm model, and perform model training and data outputting based on a comparison value (a first comparison value).

Step S06: Accumulate a certain charging and energy supply value, input collected real-time data into the characteristic database, and enrich the characteristic database in combination with application scene characteristics of the charging station and the charged electric vehicle. During actual application, the charging demand information of the electric vehicle, charging work information, power supply information, and environmental information of the charging facility are collected in real time, to create the characteristic database.

Step S07: Perform model learning training and numerical analysis based on the enriched feature database, output a comparison value (a second comparison value) based on a numerical analysis result, and control use of a charging terminal in combination with a charging status of the charging terminal and demand information of the electric vehicle.

Step S08: Output an optimized control model of energy control supply-demand balance of a charging system.

It should be understood that, after the deep learning time series prediction algorithm model is formed, the model needs to be continuously trained, verified and optimized by inputting real-time values in combination with an actual charging application scenario, to output an optimized control model of energy control supply-demand balance of the charging system. The charging and energy supply optimization method is continuously optimized, and flexibly adjusted and changed based on an actual situation, to maximize charging and power consumption efficiency of the charging facility system.

It should be noted that when accumulating a certain amount of charging and power supply values, an algorithm can be set based on different scenarios or user requirements to enter learning training and numerical analysis. According to application scene characteristics of a charging station and a to-be-charged electric vehicle, a historical database and a real-time database are enriched through regularly combining collection of a large amount of data, to enrich a data surface of machine learning. Available charging and energy supply time series prediction algorithm framework models include an autoregressive model, an LSTM model, and the like, to perform deep learning to optimize an algorithm model, and provide a trend prediction that are more suitable for a relationship between charging and power supply demand in an application scenario, to adapt to coordination of supply and demand capabilities between different charging systems, to achieve a better supply and demand balance.

Specifically, step S05 of performing comparing, predicting, and optimization control on a target control amount under the pre-trained deep learning time series prediction algorithm model, and performing model training and data outputting based on a comparison value (a first comparison value) specifically includes:
inputting information about an electric vehicle connected in real time, a charging capability, a power supply capability, and an actual charging capacity of each charging terminal to the pre-trained deep learning time series prediction algorithm model;
calculating a total charging capacity and comparing the total charging capacity with a predetermined threshold, and comparing a difference between the actual charging capacity of each charging terminal, a rated output capability of the charging terminal and the charging demand of the charged electric vehicle, and performing model training and data outputting based on a comparison value; and specifically, calculating a total charging capacity and comparing the total charging capacity with a predetermined threshold, and comparing a difference between the actual charging capacity of each charging terminal, a rated output capability of the charging terminal and the charging demand of the charged electric vehicle, and performing model training and data outputting based on a comparison value; and comparing a first difference between an actual charging capacity of each charging terminal and a rated output capacity of the charging terminal and a second difference between the actual charging capacity of each charging terminal and the charging demand of the charged electric vehicle, using the first difference value and the second difference value to obtain the first comparison value, and performing model training and data output based on the first comparison value; and
when a charging demand of a new electric vehicle is received, outputting a charging power allocation command based on a data output result in combination with the actual charging capacity of the charging facility at the charging station, the charging status of the charging terminal and the demand information of the electric vehicle, and executing an energy control output sub-process, to control use of the charging terminal; or
when no charging demand of a new electric vehicle is received, return to execute a step of obtaining the charging demand information of the electric vehicle, charging work information, power supply information, and environmental information of the charging facility, to create a characteristic database.

It should be understood that the target control amount is a relationship between charging and power supply. Under the deep learning time series prediction algorithm model, processed real-time data is input to obtain a model output result. Based on the model output result, a charging power allocation instruction is output or the model continues to be trained and optimized. The model is applied to an actual charging scene, and is trained and optimized in the actual charging scene, to provide a trend prediction that is more suitable for the relationship between the charging and power supply demand in the application scene, and achieve a best supply and demand balance. When it is necessary to respond to or receive a charging demand of a new electric vehicle, a command of the charging capability training optimization unit is output to the charging capability execution management unit, to execute the energy control output sub-process to control use of the charging terminal. This meets the charging demand of the new electric vehicle, improves a utilization rate of charging terminals, and avoids the charging terminals from being idle or waste of surplus power in the system.

Specifically, step S07 of performing model learning training and numerical analysis based on the enriched feature database, outputting a comparison value (a second comparison value) based on a numerical analysis result, and controlling use of a charging terminal in combination with a charging status of the charging terminal and demand information of the electric vehicle specifically includes:
when a charging demand of a new electric vehicle is received, outputting a charging power allocation command based on an output comparison value (the second comparison value) in combination with the actual charging capacity of the charging facility at the charging station, the charging status of the charging terminal and the demand information of the electric vehicle, and executing an energy control output sub-process, to control use of the charging terminal; or
when no charging demand of a new electric vehicle is received, return to execute a step of obtaining the charging demand information of the electric vehicle, charging work information, power supply information, and environmental information of the charging facility, to create a characteristic database.

It should be understood that during a process of model learning and training and numerical analysis based on the enriched feature database, the system also responds to an actual charging demand, output a comparison value based on a numerical analysis result, and controls the charging capability execution power management unit to control use of the charging terminal, and determine the use of the charging terminal based on an output command in combination with demand information of an electric vehicle. At this time, an comparison value output control system needs to respond to or receive a charging demand of a new electric vehicle, that is, the command is output to the charging capability execution management unit through the charging capability training optimization unit, to execute the energy control output sub-process to control use of the charging terminal, to meet the charging need of the new electric vehicle, and at the same time improve the utilization rate of the charging terminals, avoiding the charging terminals from being idle or waste of surplus power in the system.

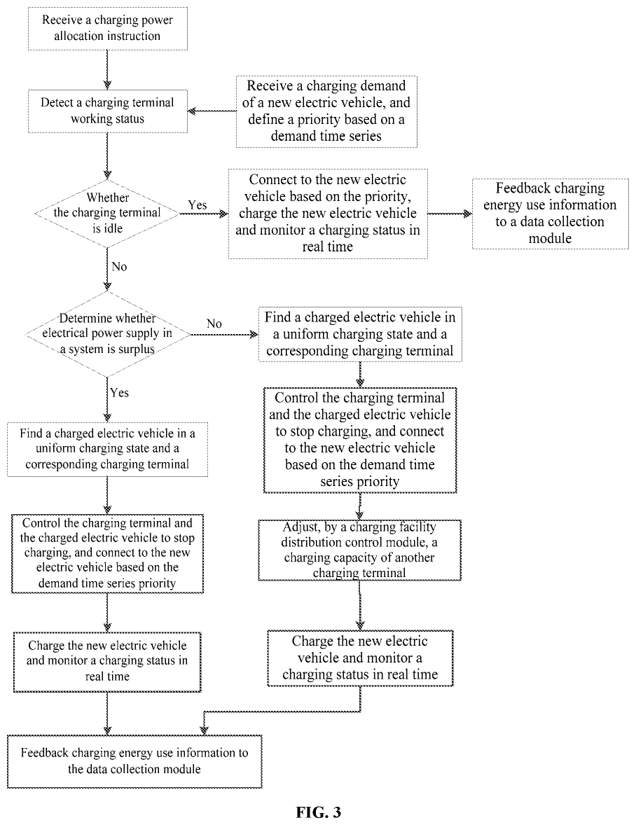

Refer to FIG. 3. Steps of the energy control output sub-process includes the following.

Receive the charging power allocation instruction.

Receive the charging demand of the new electric vehicle, and define priorities based on a demand time series.

Detect a working status of the charging terminal.

When the charging terminal is in an idle state, connect to the new electric vehicle based on a priority, charge the new electric vehicle and monitor a charging status in real time, and feedback charging energy usage information to the database.

When the charging terminal is in a non-idle state, compare whether power supply in the system is surplus.

When there is surplus of electric energy in the system, find a charged electric vehicle in a uniform charging state and a corresponding charging terminal in combination with the power demand change curve of a charging process of a power battery of a charged electric vehicle, control the charging terminal and the charged electric vehicle to stop charging, connect to a new electric vehicle based on a priority, charge the new electric vehicles and monitoring a charging status in real time, and feedback charging energy usage information to the database.

When there is no surplus of electric energy in the system, find a charged electric vehicle in a uniform charging state and a corresponding charging terminal in combination with the power demand change curve of a charging process of a power battery of a charged electric vehicle, control the charging terminal and the charged electric vehicle to stop charging, connect a new electric vehicle and starting charging, adjust a charging capacity of another charging terminal, meet a charging demand of the new electric vehicle based on a priority and monitor a charging status and energy supply adjustment in real time, and feedback charging energy usage information to the database.

It should be noted that the energy control output sub-process determines and controls the use of the charging terminal based on an output result of numerical analysis of a charging data management center in combination with the charging status of the charging terminal and the charging demand of the electric vehicle. After the data training and output module outputs an instruction, an output control process of energy optimization scheduling is specifically: while the data training and output module 4 is outputting an instruction, the charging facility distribution control module of the charging capability execution management unit 8 is also constantly monitoring the energy usage of each charging terminal in the system. Once the charging demand of the new electric vehicle is received through a mobile APP or an internet server or the man-machine interaction scheduling module 5, a priority is defined based on a demand sequence, and determining, identifying and scheduling in the system.

When the charging terminal is idle, the charging facility distribution control module arranges for new electric vehicles to be charged to be connected, and the system combines the total power available in the electrical power supply, transformation and distribution station, the actually used power, and supply and distribution of a maximum charging capacity to charge the new connected vehicle, and monitors a charging status in real time. At the same time, relevant information of a newly connected charging terminal and electric vehicle are fed back to the data collection module and entered into a large database.

When no charging terminal is idle, the charging facility distribution control module determines whether there is a surplus of electric energy supply in the system, and if there is a surplus of electric energy supply in the system, a correspondingly connected electric vehicle whose real-time charging power is less than 90% of the maximum charging capacity of each charging terminal is found. A control center can determine whether a charged electric vehicle is in a uniform charging state based on the power demand change curve during a charging process of a power battery of a charged electric vehicle in FIG. 5B. If the charged electric vehicle is in the uniform charging state, the charged electric vehicle can stop charging first to improve a utilization rate of a charging terminal. The charging terminal and a corresponding electric vehicle is controlled to stop charging, a new charged electric vehicle is connected to be charged at the same time, the new charged electric vehicle is quickly charged based on a rated capacity based on a priority and a charging status is monitored in real time. At the same time, relevant information of the charging terminal and the newly connected electric vehicle is fed back to the data collection module and entered into the large database.

When no charging terminal is idle, the charging facility distribution control module determines whether there is a surplus of electric energy supply in the system, and if there is no surplus of electric energy supply in the system, a correspondingly connected electric vehicle whose real-time charging power is less than 90% of the maximum charging capacity of each charging terminal is found. A control center can determine whether a charged electric vehicle is in a uniform charging state based on the power demand change curve during a charging process of a power battery of a charged electric vehicle in FIG. 5B. If the charged electric vehicle is in the uniform charging state, the charged electric vehicle can stop charging preferentially to improve a utilization rate of a charging terminal. The charging terminal and a corresponding electric vehicle are controlled to stop charging, and a new charged electric vehicle is connected and starts charging. At the same time, a charging capacity of another charging terminal where a charging capacity of the charged electric vehicle is in a significant decline is adjusted by using the charging facility distribution control module. Through output energy scheduling of relevant output points in the network, a charged electric vehicle with a priority requirement can be charged and a charging status and energy supply adjustment is monitored in real time. At the same time, information related to each relevant charging terminal and a connected electric vehicle is fed back to the data collection module and entered into the large database.

Preferably, when no charging terminal is idle, the charging facility distribution control module determines whether there is a surplus of electric energy supply in the system. If there is no surplus of electric energy supply in the system, under interconnection of multi-network charging piles/facilities charging capability management system, complementary scheduling of cross-station resources can be implemented, that is, to recommend a charging electric vehicle with a new demand to a nearby charging station with an idle power resource for charging preferentially.

Refer to FIG. 2. After step S08 of outputting an optimized control model of energy control supply-demand balance of the charging system, the method further includes: S09: After training to output and save the optimized control model of energy control supply-demand balance of the charging system, perform a machine learning training every preset time period to optimize the control model of energy control supply-demand balance of the charging system.

It should be understood that, on the basis of the control model of energy control supply-demand balance of a charging system formed by training, machine learning training is performed every preset time period, and a charging priority of a plurality of charging terminals is adjusted once, so that charging positions corresponding to the plurality of charging terminals perform power distribution and adjustment to adapt to different seasons and changes in different new energy vehicle users, to optimize overall charging efficiency, and integrate charging needs of different types of vehicles and mobile charging energy storage facilities.

A deep learning training environment of this embodiment adopts a Facebook open source PyTorch framework, an open source GUN/Linux operating system based on a Ubuntu operating system, a default PyTorch installation environment, based on relevant intelligent data and models, including Anaconda package management tool, mirroring settings, visualization tools, GPU (image processor), and the like, and builds a training model by embedding a developed charging facility management system based on the deep learning time series prediction of the present disclosure. Users can also configure the Ubuntu operating system through a server, migrate and implant the database of this learning system for remote interaction.

Specifically, the initial threshold related to the charging capacity includes: a maximum power supply capability of an electrical power supply, transformation and distribution station of the charging system, a total rated charging capability of charging facilities, a rated charging capacity of each charging facility and a quantity and location information of a charging terminal thereof.

It should be understood that by setting an initial threshold related to a charging capacity in the model, selecting a learning model in combination with an application scenario and inputting the initial threshold of a specific charging system, a charging system energy optimization operation pre-training model is established to dynamically analyze and process charging and energy supply capabilities of the charging system, and clarify a state characteristics of the application scenario.

Specifically, the charging demand information of the electric vehicle, charging work information, power supply information, and environmental information of the charging facility specifically include: a working information status parameter of the charging facility, vehicle quantity and model parameters of charged electric vehicles, a charging demand parameter of the charged electric vehicle, a power supply capability parameter, an environmental status parameter, working status scene data, and a man-machine interaction control parameter.

It should be noted that collection of working information status parameter of the charging facility includes charging power and charging time, real-time power and accumulated power, which come from a charging facility and a terminal thereof or a BMS management system of a charged electric vehicle, which are used for real-time management and control while entering the database, and support machine learning and training verification. The vehicle quantity and model parameters of charged electric vehicles are collected from a license plate recognition signal of a charging terminal or an electric vehicle, and the information is entered into a database, which are used for AI control model training, matching, verification, to formulate a system optimization scheduling model that combines charging capability and a charging demand and schedule the system optimization scheduling model in real time. The charging demand parameter is collected from an electric vehicle charging request and a real-time charging status, including charging terminal matching and demand information of an electric vehicles being charged, which are used for AI training, matching, verification, to formulate a system optimization scheduling model that combines charging capability and a charging demand and schedule the system optimization scheduling model in real time. The power supply capability parameter is collected from status information from an electrical power supply, transformation and distribution station, including a maximum power supply capability, a historical power supply capacity, and real-time energy supply data, which are used for AI training, matching, verification, to formulate a system optimization scheduling model that combines charging capability and a charging demand and schedule the system optimization scheduling model in real time. The environmental status parameter is mainly to collect temperature and humidity, state information from the electrical power supply, transformation and distribution station and collection of key points of devices in a system, which are used for training, matching, verification and optimization of a control model, and support system work optimization in different scenarios, and monitor and protect a working status of key points. The working status scene data collection is mainly about system monitoring and smart device working status recognition, including images and data of charging facilities, charging interfaces, electric vehicles, and the like, to support model data training, verification and optimization of control system decision-making and control capabilities. The man-machine interaction control parameter is collected from a man-machine interaction scheduling unit, a charging APP terminal and a remote server, including real-time status data and model adjustment, setting demand information, and is directly used as input to realize on-site or remote man-machine collaborative parameters to participate in calculation, control and scheduling.

Refer to FIG. 4. The present disclosure further provides a charging and power supply optimization apparatus for a charging management system, including:
a data collection module 2, configured to obtain information about power supply, transformation and distribution of a charging station, capability information of a charging facility, output information of a charging terminal, and charging demand information of an electric vehicle;
a data management module 1, configured to determine a charging capability, a power supply capability, and an actual charging capacity of a charging facility system at the charging station based on the information about power supply, transformation and distribution of the charging station, the capability information of the charging facility, the output information of the charging terminal, and the charging demand information of the electric vehicle;
a data storage module 3, configured to store the information about power supply, transformation and distribution of the charging station, the capability information of the charging facility, the output information of the charging terminal, and the charging demand information of the electric vehicle; and
a data training and output module 4, configured to input the charging capability, the power supply capability, and the actual charging capacity into a pre-trained deep learning time series prediction algorithm model, and obtain a model output result; and generate a charging power allocation instruction based on the model output result, an actual charging capacity of a charging facility at the charging station, and a charging demand of a to-be-charged electric vehicle; and
a charging capability management execution unit 8, configured to distribute electric energy to each charging facility based on the charging power allocation instruction, and charge the electric vehicle by using a charging terminal installed on the charging facility.

It should be noted that the charging and energy supply optimization device of the charging management system of the present disclosure takes a data management center as a core, including the data management module 1, the data collection module 2, the data storage module 3, the data training and output module 4, and the like. The data management module 1 serves as a processor of the data management center, supports storage and processing of various databases in the system, and is responsible for communicating with a cloud server, various charging APPs, and Wi-Fi devices to realize remote interaction of users. The data collection module 2, the data storage module 3, the data training and output module 4, the man-machine interaction scheduling module 5, and the communication module 6 together form a charging management computing center of the present disclosure, through centralized management of a plurality of charging station-level systems, the charging and energy supply optimization of the charging management system is implemented, to control a plurality of charging terminals to realize dynamic distribution of charging power.

1. A charging and power supply optimization method for a charging management system, wherein the method comprises:
S1: obtaining information about power supply, transformation and distribution of a charging station, capability information of a charging facility, output information of a charging terminal, and charging demand information of an electric vehicle;
S2: determining a charging capability, a power supply capability, and an actual charging capacity of a charging facility system at the charging station based on the information about power supply, transformation and distribution of the charging station, the capability information of the charging facility, the output information of the charging terminal, and the charging demand information of the electric vehicle;
S3: inputting the charging capability, the power supply capability, and the actual charging capacity into a pre-trained deep learning time series prediction algorithm model, and obtaining a model output result;
S4: generating a charging power allocation instruction based on the model output result, an actual charging capacity of a charging facility at the charging station, and a charging demand of a to-be-charged electric vehicle; and
S5: distributing electric energy to each charging facility based on the charging power allocation instruction, and charging the electric vehicle by using a charging terminal installed on the charging facility.

2. The charging and power supply optimization method for a charging management system according to claim 1, wherein before S1 of obtaining information about power supply, transformation and distribution of a charging station, capability information of a charging facility, output information of a charging terminal, and charging demand information of an electric vehicle, the method further comprises:
S01: selecting a machine learning pre-trained model, and setting an initial threshold and a function matrix related to a charging capacity in the machine learning pre-trained model, and establishing a time series prediction relationship model for charging and power supply optimization;
S02: setting a charging terminal characteristic parameter, obtaining a power demand change curve of a charging process of a power battery of a charged electric vehicle, to establish a time series prediction relationship of a charging working status characteristic;
S03: obtaining the charging demand information of the electric vehicle, charging work information, power supply information, and environmental information of the charging facility, to create a characteristic database; and
S04: inputting the data in the feature database into the time series prediction relationship model for charging and power supply optimization, training and optimizing the time series prediction relationship model for charging and power supply optimization in combination with the time series prediction relationship of a charging working status characteristic, to obtain the pre-trained deep learning time series prediction algorithm model.

3. The charging and power supply optimization method for a charging management system according to claim 2, wherein after S04 of inputting the data in the feature database into the time series prediction relationship model for charging and power supply optimization, training and optimizing the time series prediction relationship model for charging and power supply optimization in combination with the time series prediction relationship of a charging working status characteristic, to obtain the pre-trained deep learning time series prediction algorithm model, the method further comprises:
S05: performing comparing, predicting, and optimization control on a target control amount under the pre-trained deep learning time series prediction algorithm model, and performing model training and data outputting based on a comparison value;
S06: accumulating a certain charging and energy supply value, inputting collected real-time data into the characteristic database, and enriching the characteristic database in combination with application scene characteristics of the charging station and the charged electric vehicle;
S07: performing model learning training and numerical analysis based on the enriched feature database, outputting a comparison value based on a numerical analysis result, and controlling use of a charging terminal in combination with a charging status of the charging terminal and demand information of the electric vehicle;
S08: outputting an optimized control model of energy control supply-demand balance of a charging system.

4. The charging and power supply optimization method for a charging management system according to claim 3, wherein S05 of performing comparing, predicting, and optimization control on a target control amount under the pre-trained deep learning time series prediction algorithm model, and performing model training and data outputting based on a comparison value specifically comprises:
inputting information about an electric vehicle connected in real time, a charging capability, a power supply capability, and an actual charging capacity of each charging terminal to the pre-trained deep learning time series prediction algorithm model;
calculating a total charging capacity and comparing the total charging capacity with a predetermined threshold, and comparing a difference between the actual charging capacity of each charging terminal, a rated output capability of the charging terminal and the charging demand of the charged electric vehicle, and performing model training and data outputting based on a comparison value; and
when a charging demand of a new electric vehicle is received, outputting a charging power allocation command based on a data output result in combination with the actual charging capacity of the charging facility at the charging station, the charging status of the charging terminal and the demand information of the electric vehicle, and executing an energy control output sub-process, to control use of the charging terminal; or
when no charging demand of a new electric vehicle is received, return to execute a step of obtaining the charging demand information of the electric vehicle, charging work information, power supply information, and environmental information of the charging facility, to create a characteristic database.

5. The charging and power supply optimization method for a charging management system according to claim 3, wherein S07 of performing model learning training and numerical analysis based on the enriched feature database, outputting a comparison value based on a numerical analysis result, and controlling use of a charging terminal in combination with a charging status of the charging terminal and demand information of the electric vehicle specifically comprises:
when a charging demand of a new electric vehicle is received, outputting a charging power allocation command based on an output comparison value in combination with the actual charging capacity of the charging facility at the charging station, the charging status of the charging terminal and the demand information of the electric vehicle, and executing an energy control output sub-process, to control use of the charging terminal.

6. The charging and power supply optimization method for a charging management system according to claim 4, wherein steps of the energy control output sub-process comprise:
receiving the charging power allocation instruction;
receiving the charging demand of the new electric vehicle, and defining priorities based on a demand time series;
detecting a working status of the charging terminal; and
when the charging terminal is in an idle state, connecting to a new electric vehicle based on a priority, charging the new electric vehicle and monitoring a charging status in real time, and feeding back charging energy usage information to the database; or
when the charging terminal is in a non-idle state, comparing whether power supply in the system is surplus;
when there is surplus of electric energy in the system, finding a charged electric vehicle in a uniform charging state and a corresponding charging terminal in combination with the power demand change curve of a charging process of a power battery of a charged electric vehicle, controlling the charging terminal and the charged electric vehicle to stop charging, connecting to a new electric vehicle based on a priority, charging the new electric vehicles and monitoring a charging status in real time, and feeding back charging energy usage information to the database; or
when there is no surplus of electric energy in the system, finding a charged electric vehicle in a uniform charging state and a corresponding charging terminal in combination with the power demand change curve of a charging process of a power battery of a charged electric vehicle, controlling the charging terminal and the charged electric vehicle to stop charging, connecting to a new electric vehicle and starting charging, adjusting a charging capacity of another charging terminal, meeting a charging demand of the new electric vehicle based on a priority and monitoring a charging status and energy supply adjustment in real time, and feeding back charging energy usage information to the database.

7. The charging and power supply optimization method for a charging management system according to claim 3, wherein after S08 of outputting an optimized control model of energy control supply-demand balance of the charging system, the method further comprises:
S09: after training to output and save the optimized control model of energy control supply-demand balance of the charging system, performing a machine learning training every preset time period to optimize the control model of energy control supply-demand balance of the charging system.

8. The charging and power supply optimization method for a charging management system according to claim 2, wherein the initial threshold related to the charging capacity comprises: a maximum power supply capability of an electrical power supply, transformation and distribution station of the charging system, a total rated charging capability of charging facilities, a rated charging capacity of each charging facility and a quantity and location information of a charging terminal thereof.

9. The charging and power supply optimization method for a charging management system according to claim 2, wherein the charging demand information of the electric vehicle, charging work information, power supply information, and environmental information of the charging facility specifically comprise: a working information status parameter of the charging facility, vehicle quantity and model parameters of charged electric vehicles, a charging demand parameter of the charged electric vehicle, a power supply capability parameter, an environmental status parameter, working status scene data, and a man-machine interaction control parameter.

10. A charging and power supply optimization apparatus for a charging management system, wherein the apparatus comprises:
a data collection module, configured to obtain information about power supply, transformation and distribution of a charging station, capability information of a charging facility, output information of a charging terminal, and charging demand information of an electric vehicle;
a data management module, configured to determine a charging capability, a power supply capability, and an actual charging capacity of a charging facility system at the charging station based on the information about power supply, transformation and distribution of the charging station, the capability information of the charging facility, the output information of the charging terminal, and the charging demand information of the electric vehicle;
a data storage module, configured to store the information about power supply, transformation and distribution of the charging station, the capability information of the charging facility, the output information of the charging terminal, and the charging demand information of the electric vehicle.
a data training and output module, configured to input the charging capability, the power supply capability, and the actual charging capacity into a pre-trained deep learning time series prediction algorithm model, and obtain a model output result; and generate a charging power allocation instruction based on the model output result, an actual charging capacity of a charging facility system at the charging station, and a charging demand of a to-be-charged electric vehicle; and
a charging capability management execution unit, configured to distribute electric energy to each charging facility based on the charging power allocation instruction, and charge the electric vehicle by using a charging terminal installed on the charging facility.

11. The charging and power supply optimization method for a charging management system according to claim 5, wherein steps of the energy control output sub-process comprise:
receiving the charging power allocation instruction;
receiving the charging demand of the new electric vehicle, and defining priorities based on a demand time series;
detecting a working status of the charging terminal; and
when the charging terminal is in an idle state, connecting to a new electric vehicle based on a priority, charging the new electric vehicle and monitoring a charging status in real time, and feeding back charging energy usage information to the database; or
when the charging terminal is in a non-idle state, comparing whether power supply in the system is surplus;
when there is surplus of electric energy in the system, finding a charged electric vehicle in a uniform charging state and a corresponding charging terminal in combination with the power demand change curve of a charging process of a power battery of a charged electric vehicle, controlling the charging terminal and the charged electric vehicle to stop charging, connecting to a new electric vehicle based on a priority, charging the new electric vehicles and monitoring a charging status in real time, and feeding back charging energy usage information to the database; or
when there is no surplus of electric energy in the system, finding a charged electric vehicle in a uniform charging state and a corresponding charging terminal in combination with the power demand change curve of a charging process of a power battery of a charged electric vehicle, controlling the charging terminal and the charged electric vehicle to stop charging, connecting to a new electric vehicle and starting charging, adjusting a charging capacity of another charging terminal, meeting a charging demand of the new electric vehicle based on a priority and monitoring a charging status and energy supply adjustment in real time, and feeding back charging energy usage information to the database.
